(19) United States
(12) Patent Application Publication
(10) Pub. No.: US 2004/0204129 A1
(43) Pub. Date: Oct. 14, 2004

(54) Touch-sensitive user interface

(76) Inventors: David M. Payne, Star, ID (US); Richard Lee Payne, Caldwell, ID (US)

Correspondence Address: HEWLETT-PACKARD COMPANY, Intellectual Property Administration, P.O. Box 272400, Fort Collins, CO, 80527-2400, US

(21) Appl. No.: 10/218,282

(22) Filed: Aug. 14, 2002

(51) Int. Cl. H04B 1/38; H04M 1/00

(52) U.S. Cl. 455/566; 455/90.3; 455/550.1; 455/575.1

(57) ABSTRACT

Systems and methods are described for facilitating interface of a user with an electrical device. In one arrangement, a system and method include providing a touch-sensitive screen to the user and presenting at least one selectable feature to the user with the touch-sensitive screen, the selectable feature having associated therewith multiple functions, wherein a first function is performed when the feature is selected using a detected relatively light touch and wherein a second function is performed when the feature is selected using a detected relatively firm touch.

### FIELD OF THE INVENTION

The present disclosure relates to user interfaces. More particularly, the disclosure relates to touch-sensitive user interfaces that can distinguish between a light and a firm touch of the user.

### BACKGROUND OF THE INVENTION

Many electrical devices comprise touch-sensitive screens, sometimes referred to a touchscreens, which allow the user to control operation of the device. Examples of such devices include office-type equipment such as printers, photocopiers, facsimile machines, scanners, multi-function peripheral (MFP) devices, as well as personal devices such as personal digital assistants (PDAs) and mobile telephones. Indeed, such touch-sensitive screens are used in other environments such as automated teller machines (ATMs), gasoline pumps, cash registers, etc.

The touch-sensitive screens often comprise liquid crystal displays (LCDs) that provide graphical representations of various buttons or other features that the user may select by simply pressing on the screen with a finger or stylus. In that no actual buttons are provided, touch-sensitive screens permit many different features to be presented using the screen. Specifically, the features displayed on the screen can be changed such that various different sets of features (e.g., buttons) can be presented to the user for selection. By way of example, these different sets of features may be accessed by selecting different tabs of virtual folders, causing a drop-down menus to appear, and the like.

Although providing flexibility of use, conventional touch-sensitive interfaces are not useful to all persons. For example, in that the user must be able to see the displayed features to properly select them, blind or otherwise visually-impaired persons may not be able to use a touch-sensitive screen and, therefore, may not be able to operate an electrical device that comprises such a screen. Accordingly, even though such users can physically select a feature, e.g., are capable of pressing a button displayed on the screen, they may not be capable of finding the feature they would like to select.

In view of the above, it can be appreciated that it would be desirable to be able to have a touch-sensitive user interface that provides improved functionality and therefore can be accessed and used by a greater number of persons, even those who are visually-impaired.

### SUMMARY OF THE INVENTION

The present disclosure relates to interfacing with an electrical device. Therefore, systems and methods are described for facilitating interface of a user with an electrical device. In one arrangement, a system and method comprises providing a touch-sensitive screen to the user and presenting at least one selectable feature to the user with the touch-sensitive screen, the selectable feature having associated therewith multiple functions, wherein a first function is performed when the feature is selected using a detected relatively light touch and wherein a second function is performed when the feature is selected using a detected relatively firm touch.

### BRIEF DESCRIPTION OF THE DRAWINGS

The invention can be better understood with reference to the following drawings. The components in the drawings are not necessarily to scale.

FIG. 1 is a schematic view of a first example electrical device incorporating a touch-sensitive user interface.

FIG. 2 is a schematic view of a second example electrical device incorporating a touch-sensitive user interface.

FIG. 3 is a block diagram of an example configuration of the electrical devices of FIGS. 1 and 2.

FIG. 4 is a flow diagram that illustrates an example of use of an electrical device using a touch-sensitive user interface.

FIG. 5A is a schematic representation of a user interfacing with a first example touch-sensitive screen using a relatively light touch.

FIG. 5B is a schematic representation of an array of sensors of the touch-sensitive screen shown in FIG. 5A, illustrating a relatively small number of sensors being activated during a relatively light touch.

FIG. 6A is a schematic representation of a user interfacing with the first example touch-sensitive screen using a relatively firm touch.

FIG. 6B is a schematic representation of an array of sensors of the touch-sensitive screen shown in FIG. 6A, illustrating a relatively large number of sensors being activated during a relatively firm touch.

FIG. 7 is a schematic representation of a user interfacing with a second example touch-sensitive screen using a relatively light touch.

FIG. 8 is a schematic representation of a user interfacing with the second example touch-sensitive screen using a relatively firm touch.

### DETAILED DESCRIPTION

As noted above, conventional touch-sensitive user interfaces have limited usability, especially for visually-impaired persons. However, as is described in greater detail below, expanded usability can be obtained where the touch-sensitive user interface of an electrical device is configured to distinguish between relatively light and finn touches of the user. With such functionality, non-visual feedback can be presented to the user to aid the user in operating the electrical device that incorporates the touch-sensitive user interface. In addition to aiding visually-impaired users, such a touch-sensitive user interface can similarly provide guidance to non-impaired users as to operation of the electrical device or can provide for multi-functionality of various features presented with the screen.

Disclosed in the following are systems and methods that facilitate the above-described user interfacing. Although specific systems and methods are described herein, it is to be understood that these systems and methods are mere embodiments that are provided by way of example for purposes of describing the manners in which interface with an electrical device can be facilitated.

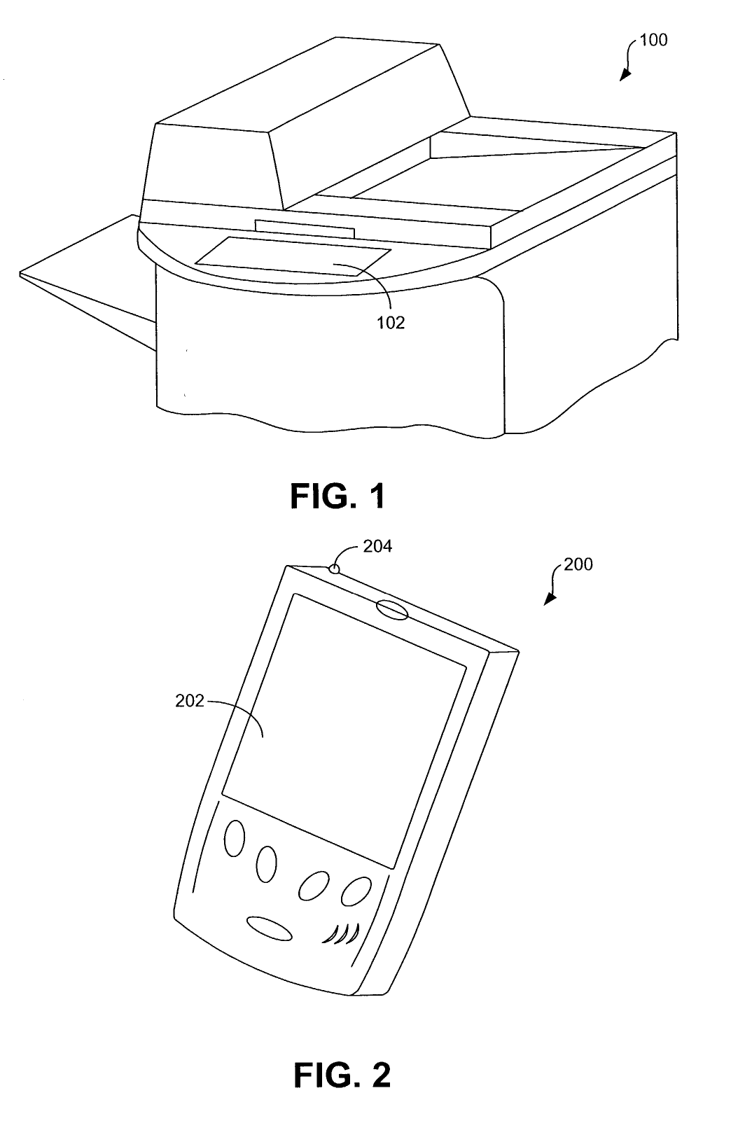

Referring now in more detail to the drawings, in which like numerals indicate corresponding parts throughout the several views, FIG. 1 illustrates a first example electrical device 100 that incorporates a touch-sensitive user interface comprising a touch-sensitive screen 102. As indicated in FIG. 1, the electrical device 100 can comprise an office-type device such as a printer. Although a printer is specifically illustrated in FIG. 1, persons having ordinary skill in the art will appreciate that the electrical device 100 can just as easily comprise another office-type device such as a photocopier, facsimile device, scanner, multi-function peripheral (MFP), etc. As is discussed in greater detail below, the touch-sensitive screen 102 can be used to display graphical representations of features that may be selected by a user, for instance by pressing on the screen with one's fingers.

FIG. 2 illustrates a second example electrical device 200 that incorporates a touch-sensitive user interface comprising a touch-sensitive screen 202. In this example, the electrical device 100 comprises a personal device and, in particular, a personal digital assistant (PDA). Although a PDA is specifically illustrated and described herein, it will be appreciated by persons having ordinary skill in the art that the electrical device 200 can comprise another personal device such as a mobile telephone, pager, etc. As is with the electrical device 100 discussed above, the touch-sensitive screen 202 can be used to display graphical representations of features that may be selected by a user. These features can be selected using one's finger and/or using a stylus 204 (or other interface element) that may be included with the electrical device 200.

Although specific types of electrical devices have been identified with reference to FIGS. 1 and 2, it is to be understood that these devices are only identified for purposes of example. The identification of these devices is in no way intended to limit the scope of the present disclosure. Indeed, it is to be understood that the present disclosures pertains to substantially any electrical device that incorporates a touch-sensitive user interface.

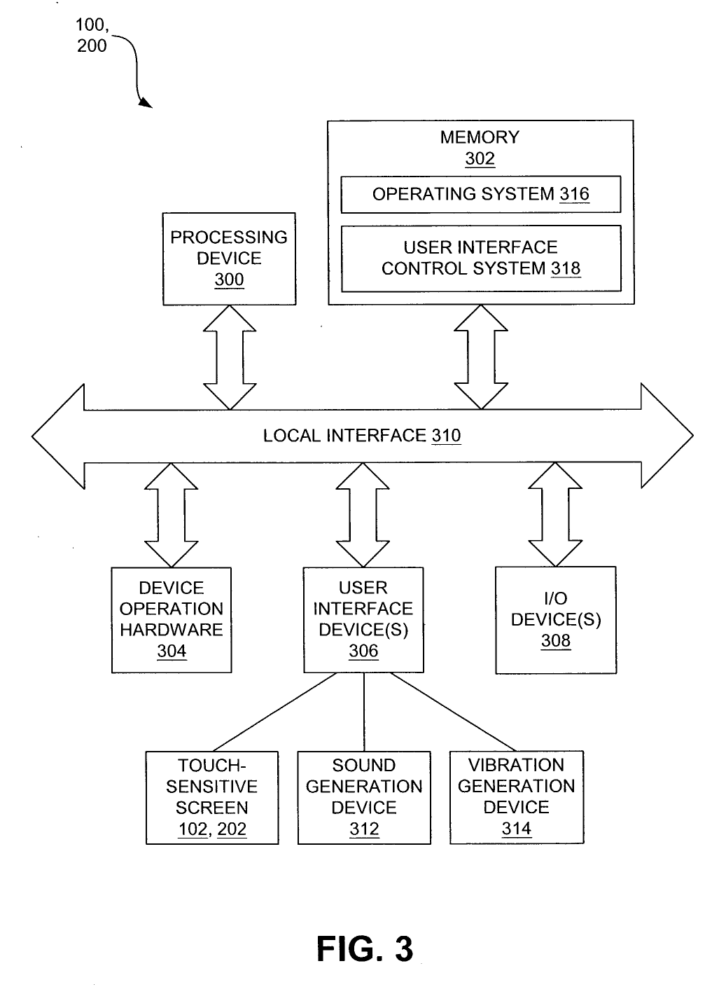

FIG. 3 is a block diagram of an example configuration for the electrical devices 100, 200 shown in FIGS. 1 and 2. As indicated in FIG. 3, the electrical device 100, 200 can comprise a processing device 300, memory 302, device operation hardware 304, user interface devices 306, and one or more input/output (I/O) devices 308. Each of these components is connected to a local interface 310 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the electrical device 100, 200. The memory 302 can include any one of a combination of volatile memory elements (e.g., random access memory (RAM)) and nonvolatile memory elements (e.g., Flash memory, magnetic random access memory (MRAM)).

The nature of the device operation hardware 304 depends upon the particular nature of the electrical device 100, 200. Generally speaking, however, this hardware 304 comprises the components used to satisfy the basic operations of the electrical device 100, 200. To cite an example, this hardware 304 may comprise a print engine where the device is a printer or other such imaging device.

The user interface devices 306 comprise the interface tools with which the device settings can be changed and through which the user can communicate commands to the device 100, 200. As identified in FIGS. 1 and 2, the user interface devices 306 typically comprise a touch-sensitive screen 102, 202. The configuration of this touch sensitive screen 102, 202 can vary depending upon the application and/or the desired functionality. In one arrangement, the touch-sensitive screen 102, 202 can comprise a touch-sensitive screen comprising a two dimensional array of resistive, capacitive, or inductive sensors. Many such touch-sensitive screens are known in the art. Alternatively, the touch-sensitive screen 102, 202 can comprise an acoustic or light wave-based screen in which contact with the screen interrupts or modifies acoustic or light waves that traverse a grid of the screen. Again, several such touch-sensitive screens are known in the art.

The user interface devices 306 may further include a sound generation device 312 that is used to generate audible feedback for the user, and a vibration generation device 314 that is used to generate tactile feedback for the user. By way of example, the sound generation device 312 includes a speaker that is internally or externally mounted to the electrical device. The vibration generation device 314 can, for instance, include a solenoid actuator, motor, or other device capable of generating vibrations that can be sensed by the user when directly or indirectly touching the electrical device 100, 200. In one embodiment, the vibration generation device 314 is internally mounted within the electrical device 100, 200 so as to create vibrations that propagate through the touch-sensitive screen 102, 202. The nature and operation of the user interface devices 306 is described in greater detail below.

The one or more I/O devices 308 comprise components used to facilitate connection of the electrical device 100, 200 to another device. These I/O devices 310 can, for instance, comprise one or more serial, parallel, small system interface (SCSI), universal serial bus (USB), or IEEE 1394 (e.g., Firewire™) connection devices.

The memory 302 includes various code (software and/or firmware) including an operating system 316 and a user interface control system 318. The operating system 316 contains the various commands used to control the general operation of the electrical device 100, 200. The user interface control system 318 comprises the various code used to control operation of the user interface devices 306 as well as determine which commands or other selections have been made using the touch-sensitive screen 102, 202 of the electrical device 100, 200. As is described in greater detail below, the user interface control system 318 is capable of distinguishing between relatively light user touches and relatively firm user touches, and is capable of controlling operation of the user interface devices 306 as a function of whether a light touch or firm touch has been detected.

Various code has been identified above. It is to be understood that this code can be stored on any computer-readable medium for use by or in connection with any computer-related system or method. In the context of this document, a computer-readable medium is an electronic, magnetic, optical, or other physical device or means that can contain or store code (e.g., in the form of a computer program) for use by or in connection with a computer-related system or method. The code can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. The term “computer-readable medium” can be any means that can store, communicate, propagate, or transport the code for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable media include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, examples of operation of the systems will now be discussed. In the discussions that follow, flow diagrams are provided. It is to be understood that any process steps or blocks in these flow diagrams may represent modules, segments, or portions of code that include one or more executable instructions for implementing specific logical functions or steps in the process. It will be appreciated that, although particular example steps are described, alternative implementations are feasible. Moreover, steps may be executed out of order from that shown or discussed, including substantially concurrently or in reverse order, depending on the functionality involved.

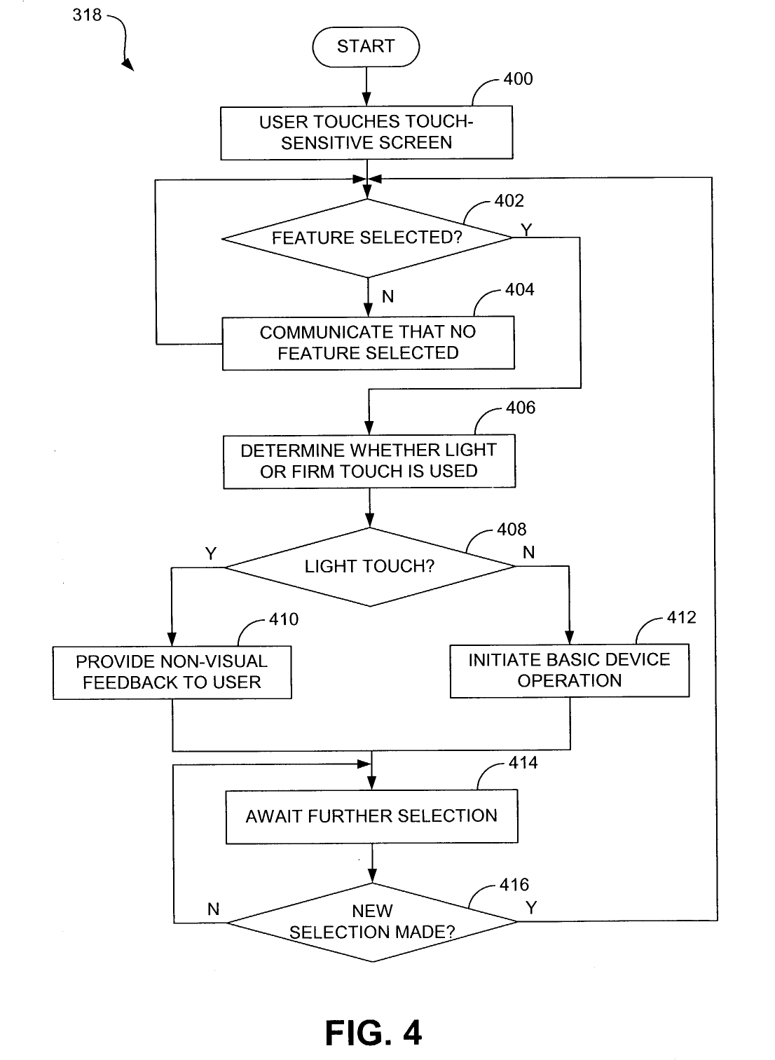

As noted above, it would be desirable to be able to distinguish between relatively light and firm user touches to provide aid to the user, whether visually-impaired or not, in operating the electrical device. An example of operation of the electrical device, and more particularly the user interface control system 318, is provided in FIG. 4. Beginning with block 400 of this figure, a user touches the touch-sensitive screen of the electrical device. This “touching” can comprise direct touching of the screen using, for example, a finger or indirect touching using, for example, a stylus. In either case, it can then be determined whether a graphical feature, for instance an on-screen button, has been selected, as indicated in decision block 402. Stated in other words, it can be determined whether the user's area of touch coincides with one or more graphical features displayed in the touch-sensitive screen. If no such feature has been selected, the user interface control system 318 communicates to the user that no feature has been selected, as indicated in block 404.

Normally, this communication is non-visual to aid visually-impaired persons. In one arrangement, the communication can comprise a recorded or synthesized voice message generated with the sound generation device that states “no feature selected” or other appropriate message. In another arrangement, the communication can comprise a simple sound such as one or more tones or beeps that indicate the no selected feature condition to the user. In yet another arrangement, the communication can comprise some form of tactile feedback. For example, the communication can comprise one or more vibrations generated with the vibration generation device that indicate the no selected feature condition. In addition to merely identifying to the user that no graphical feature has been selected, the user interface control system 318 can also, if desired, provide instruction as to which direction on the touch-sensitive screen to move one's finger or stylus to find selectable features. For instance, an audible instruction stating “move left for the scan button” or other such guidance could be provided.

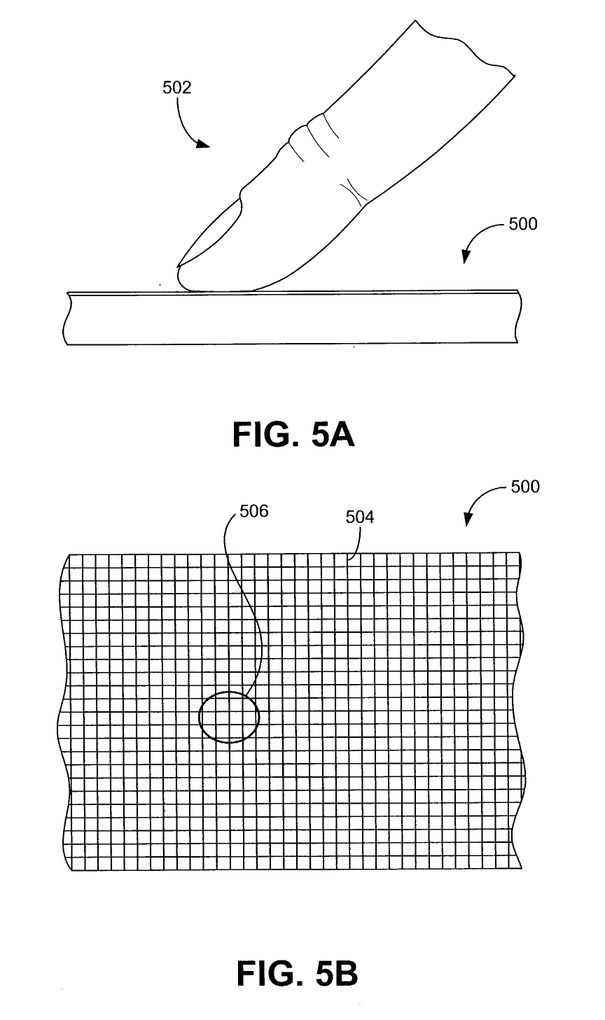

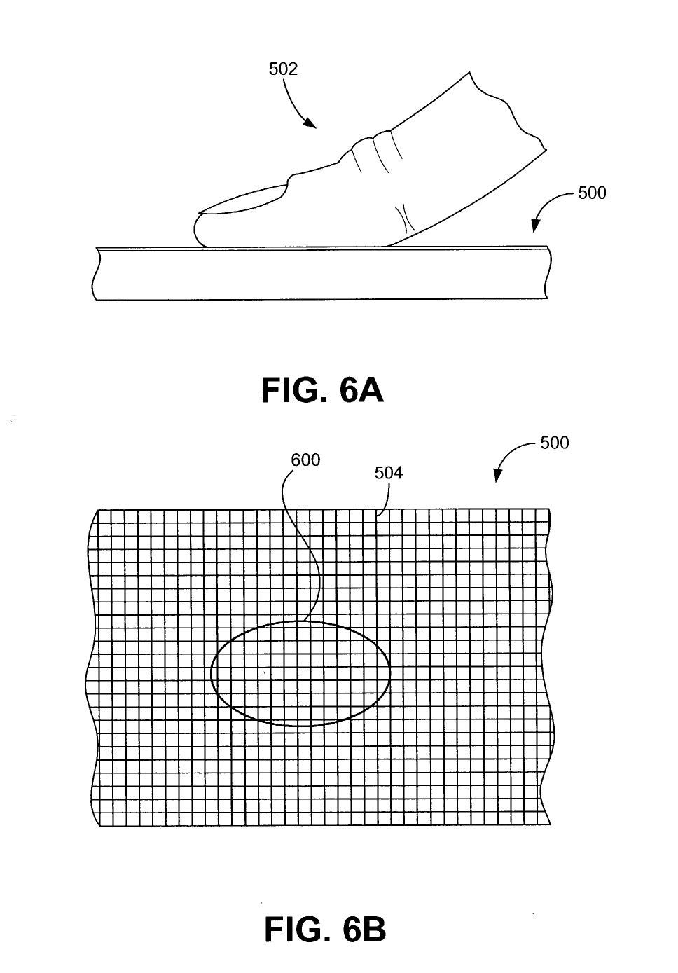

Irrespective of the manner in which the no selected feature condition is communicated to the user, the user can then modify his or her selection so that flow returns to decision block 402 and a new determination made as to whether a graphical feature has been selected. Assuming that the user has now moved his or her finger or stylus so as to coincide with a selectable feature presented with the touch-sensitive screen, it can then be determined whether the user is making the selection using a light or firm touch, as indicated in block 406. This determination can be made in several different ways. FIGS. 5 and 6 illustrate a first example touch firmness determination method. FIG. 5A illustrates a user touching a touch-sensitive screen 500 using his or her index finger using a relatively light touch. As is apparent from FIG. 5A, this relatively light touch is achieved by only using the tip of the finger 502 with light pressure to contact the touch-sensitive screen 502.

FIG. 5B schematically illustrates the touch-sensitive screen 500 during the light-touch selection shown in FIG. 5A. As indicated in FIG. 5B, the touch-sensitive screen 500 comprises an array of sensors, represented by grid 504, with a sensor being located at each intersection of the grid. The bounds of the area of contact made between the user's finger 502 and the screen 502 is represented with ellipse 506. Due to the relatively light touch used to make the selection, this area of contact is relatively small and, therefore, the number of affected (i.e., activated) sensors is likewise relatively small. This condition can be interpreted by the user interface control system 318 as representing a light touch.

FIG. 6A illustrates a user touching the touch-sensitive screen 500 with a relatively firm touch. As indicated in this figure, firm touching of the screen 500 can result in a greater contact area being formed between the user's finger and the screen. This can occur, at least in part, due to deflection of the user's finger tip when more force is used to press against the screen 500. As indicated in FIG. 6B, this relatively firm touch results in a relatively large contact area, represented by ellipse 600, and, therefore, a relatively large number of sensors being activated. This condition can be interpreted by the user interface control system 318 as representing a firm touch.

As can be appreciated from the foregoing description, what constitutes a relatively light or firm touch may depend upon the surface area covered by the user when touching the screen (either directly or indirectly). In that finger sizes vary depending on the user (e.g., child fingers versus adult fingers), selection or calibration may be required to obtain the most accurate results when direct touching is anticipated. Selection may comprise switching the user interface between a children or adult setting. Calibration may comprise having the use select a feature using a light touch and then a firm touch to permit the user interface control system 318 to recognize the difference. Alternatively, the user interface control system 318 can be configured to “learn” the difference between light and firm touches if feedback is presented to the system from the user.

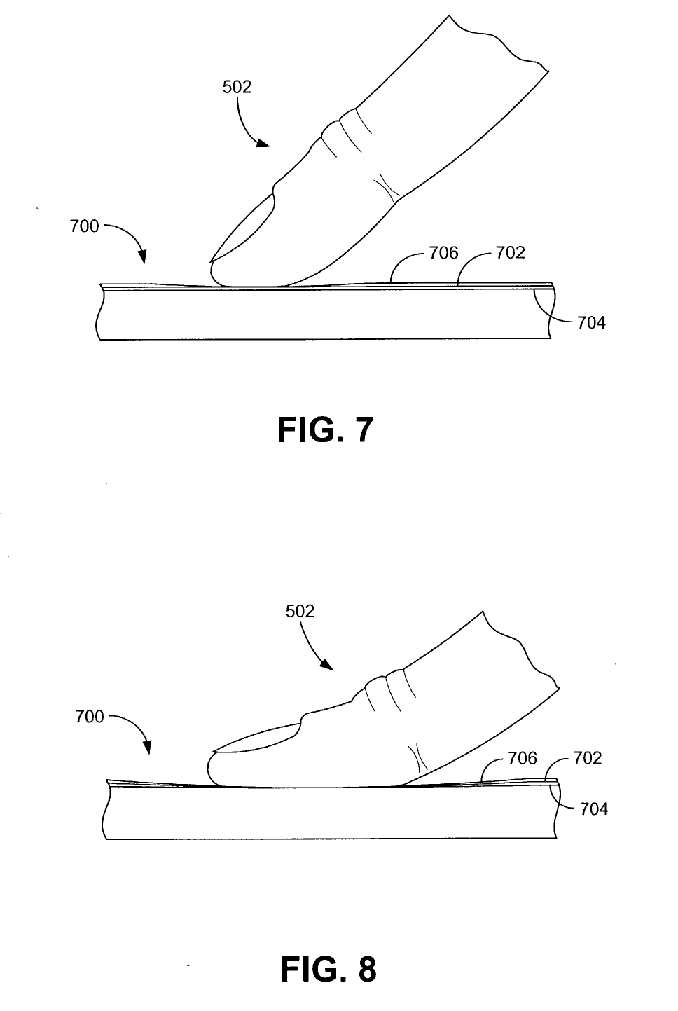

FIGS. 7 and 8 illustrate a second example touch firmness determination method. In this method, the touch-sensitive screen 700 is configured to distinguish between light pressure and firm pressure. This capability can be achieved by providing two or more arrays, e.g., light wave-based arrays, in a stacked arrangement. For example, as indicated in FIGS. 7 and 8, the touch-sensitive screen 700 can be provided with first and second arrays 702 and 704 that are provided below a deformable outer layer 706. With such an arrangement, a relatively light touch only results in the sensors of the first array 702 being activated, as shown in FIG. 7. However, when a relatively firm touch is used, as indicated in FIG. 8, sensors of both layers 702, 704 are activated.

Although each of FIGS. 5-8 illustrate methods for detecting direct touching, it will be appreciated that these methods could similarly be used to detect indirect touching, e.g., touching using a stylus. In the method described with respect to FIGS. 5 and 6, such a stylus may need to comprise a pliable tip to emulate the amount of contact area formed when a human finger is used. However, a conventional stylus could be used in the method described with respect to FIGS. 7 and 8 in that the touch-sensitive screen 700 is specifically configured to distinguish between light and firm pressure irrespective of the amount of contact area that results.

With reference back to FIG. 4 and decision block 408, if a relatively light touch (selection) is detected, flow continues to block 410 at which the user is provided with non-visual feedback. The nature of this feedback can vary depending upon the selected feature as well as the desired mode of operation. Again, the feedback can comprise auditory or tactile feedback. In an auditory arrangement, the feedback can comprise an audible description in words of the feature that the user has selected using the light touch. For example, when a “duplex” button is selected, a voice message can simply state “duplex.” In a tactile arrangement, a predetermined number of physical taps or other vibrations representative of the selected feature can be made against the touch-sensitive screen or adjacent component by the vibration generation device. With such operation, relatively light selection of the various buttons or other features displayed in the touch-sensitive screen can be described to the user in similar manner to the visual description obtained during a “mouse-over” of buttons using a cursor in the Microsoft Windows™ environment. Accordingly, the user's finger can be used in similar manner as an on-screen cursor to explore and/or navigate the interface. In that the feedback is non-visual, however, descriptions can be provided to visually-impaired persons, thereby permitting them to use the electrical device.

If a light touch was not detected, i.e. a firm touch was detected, flow instead continues to block 412 at which the user selection is entered and an associated basic device operation is initiated. For example, where the selected button was a “duplex” button, the user interface control system 318 can detect a firm selection of the button and set the device for duplex copying. Accordingly, it will be appreciated that by being able to distinguish between relatively light and firm touches the user interface control system 318 can enable multiple functionality of various features presented with the touch-sensitive screen.

Next, the user interface control system 318 awaits a further selection, as indicated in block 414 until such time when the user or another user touches the touch-sensitive screen. With reference to decision block 416, if a new selection is made, flow returns to block 402 described above. Otherwise, flow returns to block 414 and a selection is still awaited.

In the mode of operation described in relation of FIG. 4, various feedback is provided to the user to aid the user in operating the electrical device. The amount of information provided can, optionally, be relatively detailed or relatively sparse depending upon user preferences. For instance, when the electrical device is first used or first used by a given user, the electrical device may be placed in a teaching mode in which a relatively large amount of feedback is provided to users. With this mode, the users can become more familiar with device operation as well as the layout of the features of the touch-sensitive screen. As this familiarity increases, a normal operation mode may be used that still provides feedback, although less detailed feedback. Accordingly, a user, for instance a visually-impaired user, can initially operate the electrical device in a teaching mode when both auditory and tactile feedback is provided and later operate the electrical device in a normal operation mode in which the auditory feedback is removed or curtailed, but the tactile feedback remaining which, by that point, the user associates with the various features presented with the touch-sensitive screen.

In addition to varying the amount of information provided depending upon the selected operating mode, the amount of information provided can vary depending upon the amount of time that the selected feature is touched (directly or indirectly). For instance, by lightly touching a given button, the main function associated with the button can be indicated. In such a case, the electrical device may audibly announce “copy” for a copying start button. If the light touch is maintained, however, further information and/or instruction can be provided. In such a case, the electrical device may describe what action will occur if the user fully selects the button using a firm touch. As will be appreciated by persons having ordinary skill in the art, many variations on this theme are possible. For example, selecting a given feature for an extended period of time may, alternatively, cause directional instructions of the user interface to be provided. Accordingly, the user can be told where his or her finger or stylus is positioned on the touch-sensitive screen and which buttons are adjacent that finger or stylus.

As will be appreciated by persons having ordinary skill in the art, additional functionality may be facilitated where the control system 318 is capable of distinguishing between relatively light and firm touches. For instance, multiple functionality (i.e., device operations) can be associated with the presented buttons or other on-screen features so that more electrical device operations can be controlled by the user with a given set of selectable features. To provide a specific example, a given button be associated with a collating function and a stapling function. In such a case, collating may be selected when the button is lightly selected, and collating/stapling may be selected when the button is firmly selected. Operation in such a manner enables provision of fewer buttons and/or sets of buttons for which the user must become familiar. Therefore, the light versus firm touch determination is not only useful in aiding the visually-impaired but, more generally, facilitates alternative modes of operation not currently feasible with existing touch-sensitive user interfaces.

While particular embodiments have been disclosed in detail in the foregoing description and drawings for purposes of example, it will be understood by those skilled in the art that variations and modifications thereof can be made without departing from the scope of the invention as set forth in the following claims.

What is claimed is:

1. A method for facilitating interface of a user with an electrical device, comprising:
providing a touch-sensitive screen to the user; and
presenting at least one selectable feature to the user with the touch-sensitive screen, the selectable feature having associated therewith multiple functions, wherein a first function is performed when the feature is selected using a detected relatively light touch and wherein a second function is performed when the feature is selected using a detected relatively firm touch.

2. The method of claim 1, wherein the first function pertains to non-visually identifying a device operation associated the selected feature to the user.

3. The method of claim 2, wherein the step of non-visually identifying a device operation comprises audibly identifying the operation to the user.

4. The method of claim 3, wherein the step of audibly identifying the device operation to comprises describing the feature to the user in words.

5. The method of claim 2, wherein the step of non-visually identifying a device operation comprises identifying the operation to the user using one or more vibrations that the user can sense.

6. The method of claim 1, wherein the first function comprises performing a first basic device operation and the second function comprises performing a second basic device operation.

7. The method of claim 1, wherein the second function comprises performing a basic device operation.

8. A method for facilitating interface of a user with an electrical device, comprising:
providing a touch-sensitive screen to the user;
presenting selectable features to the user with the touch-sensitive screen;
detecting whether a feature has been selected using a relatively light touch or a relatively firm touch;
non-visually identifying the feature if it was selected using a relatively light touch; and
initiating performance of a basic operation associated with the feature if it was selected using a relatively firm touch.

9. The method of claim 8, wherein the step of presenting selectable features comprises presenting one or more graphical buttons to the user.

10. The method of claim 8, wherein the step of detecting comprises determining whether a relatively large number or a relatively small number of touch-sensitive screen sensors have been activated.

11. The method of claim 8, wherein the step of detecting comprises determining whether sensors from at least two arrays of sensors have been activated.

12. The method of claim 8, wherein the step of non-visually identifying the feature comprises audibly identifying the feature to the user in words.

13. The method of claim 8, wherein the step of non-visually identifying the feature comprises identifying the feature to the user using one or more vibrations that the user can sense.

14. A user interface incorporated in an electrical device, comprising:
a touch-sensitive screen;
means for generating selectable features for presentation in the touch-sensitive screen;
means for detecting whether a feature has been selected using a relatively light touch or a relatively firm touch; and
means for non-visually identifying the feature to the user if it was selected using a relatively light touch and for initiating a basic device operation associated with the feature if it was selected using a relatively firm touch.

15. The user interface of claim 14, wherein the means for detecting comprise means for determining whether a relatively large number or a relatively small number of touch-sensitive screen sensors have been activated by the user.

16. The user interface of claim 14, wherein the means for detecting comprise means for determining whether sensors from at least two arrays of sensors have been activated.

17. The user interface of claim 14, wherein the means for non-visually describing the feature comprise a speaker.

18. The user interface of claim 14, wherein the means for non-visually describing the feature comprise a vibration generation device.

19. A user interface for an electrical device, comprising:
a touch-sensitive screen; and
a user interface control system stored on a computer-readable medium, the system including logic configured to detect whether a feature presented in the touch-sensitive screen has been selected using a relatively light touch or a relatively firm touch and logic configured to control the electrical device in a first or a second manner depending upon whether a relative light touch or a relatively firm touch was detected.

20. The user interface of claim 19, wherein the logic configured to detect comprises logic configured to determine whether a relatively large number or a relatively small number of touch-sensitive screen sensors have been activated by the user.

21. The user interface of claim 19, wherein the logic configured to detect comprises logic configured to determine whether sensors from at least two arrays of sensors have been activated.

22. The user interface of claim 19, wherein the logic configured to control the electrical device in a first manner comprises logic configured to provide a verbal identification of the selected feature to the user.

23. The user interface of claim 19, wherein the logic configured to control the electrical device in a first manner comprises logic configured to generate a vibration that can be sensed by the user and which identifies the selected feature.

24. An electrical device, comprising:
a processing device;
device operation hardware;
a user interface incorporating a touch-sensitive screen; and
memory including a user interface control system, the system including logic configured to detect whether a feature presented in the touch-sensitive screen has been selected using a relatively light touch or a relatively firm touch and logic configured to control the electrical device in a first or a second manner depending upon whether a relatively light touch or a relatively firm touch was detected.

25. The electrical device of claim 24, wherein the logic configured to detect comprises logic configured to determine whether a relatively large number or a relatively small number of touch-sensitive screen sensors have been activated by the user.

26. The electrical device of claim 24, wherein the logic configured to detect comprises logic configured to determine whether sensors from at least two arrays of sensors have been activated.

27. The electrical device of claim 24, wherein the logic configured to control the electrical device in a first manner comprises logic configured to provide a verbal identification to the user.

28. The electrical device of claim 24, wherein the logic configured to control the electrical device in a first manner comprises logic configured to generate a vibration that can be sensed by the user.
